(19) United States
(12) Patent Application Publication
(10) Pub. No.: US 2007/0069620 A1
(43) Pub. Date: Mar. 29, 2007

(54) Electrode Pattern Design For Field Emission Display

(75) Inventors: Lin-En Chou, Hsinchu (TW); Cheng-Chung Lee, Hsinchu (TW); Bing-Nan Lin, Hsinchu (TW); Wei-Yi Lin, Hsinchu (TW)

Correspondence Address: BEVER HOFFMAN & HARMS, LLP;TRI-VALLEY OFFICE, 1432 CONCANNON BLVD., BLDG. G, LIVERMORE, CA, 94550, US

(73) Assignee: Industrial Technology Research Institute, Hsinchu (TW)

(21) Appl. No.: 11/427,758

(22) Filed: Jun. 29, 2006

(30) Foreign Application Priority Data
Sep. 26, 2005 (TW) 94133403

(51) Int. Cl. H01J 1/02

(52) U.S. Cl. 313/309

(57) ABSTRACT

A novel electrode pattern design for the electrode plate of field emission device is provided. The electrode plate includes an active region having thereon an electrode layer and a non-active region having thereon a dummy structure or dummy electrode. The material of the dummy electrode is selected from one of the electrode layer materials or the material of the dummy electrode has a coefficient of thermal expansion approximately approaching what the electrode layer material has, so that the stress concentration effect occurring in the non-active region can be eliminated.

### FIELD OF THE INVENTION

The present invention relates to an electrode plate for field emission display, and in particular to a electrode pattern formed on the electrode plate for field emission display.

### BACKGROUND OF THE INVENTION

Recently, the light-weight, thinner, shorter and smaller flat panel display is widely used for replacing the traditional bulky cathode ray tube (CRT) display. Accordingly, the flat panel display technology is becoming one of the most important optoelectronic technology in the recent years. In the variety of flat panel display technologies, the liquid crystal display is one of the most popular display technology. However, since the liquid crystal display is not a self-illuminated device, an additional light source is needed for serving as the backlight of the liquid crystal display. Nevertheless, the backlight module of the liquid crystal display is not only a very complicated assembly but also has troubles in brightness degradation and in heat dissipation especially when it is scaled up for the LCD TV.

The field emission display is one of the promising display technology for the next generation flat panel display. Unlike the liquid crystal display having the complicated and the costly backlight module, the field emission display is not only self-illuminated but also has the excellent brightness and color quality approaching the traditional CRT display. While the display quality of the field emission display is approaching the traditional CRT display, the driving voltage of the field emission display is much lower than that of the CRT display. Furthermore, the fluorescent material used for field emission display has a wider operation environment over the liquid crystal material used for LCD. Thus, the field emission display holds the promise for the next generation flat panel display.

Please refer to FIG. 1, which schematically shows a structure of the field emission display according to the prior art. As shown in FIG. 1, the field emission display 100 includes an anode plate 10 and a cathode plate 20. The anode plate 10 includes a glass substrate 12 having thereon an anode electrode layer 14 and a fluorescent layer 16, while the cathode plate 20 includes another glass substrate 22 having thereon a cathode electrode layer 24 and a plurality of electron-emitting sources 26 for emitting an electron beam 25. The emitted electron beam 25 is then attracted by the anode plate 10 and rams into the fluorescent layer 16 for generating an emitted light in response to a collision of the electron beam 25. Generally, there exist the patterned anode and cathode electrodes on the respective anode electrode layers 14 and the cathode electrode layer 24 in order to precisely control the collision position of the electron beam 25 on the fluorescent layer 16. Typically, the patterned anode electrode further includes the transparent electrode and the secondary electrode (not shown). The transparent electrode is used for providing a positive voltage for the anode plate 10, so that the electron beam 25 could be driven by the positive voltage to ram into the fluorescent layer 16. The secondary electrode which is made of the low electrical resistance material is not only used for electrical connecting purpose but also acted as the opaque partition for separating each pixel of the field emission display. As to the cathode plate 20, the patterned electrode might further includes a gate electrode 28 for increasing the electron density of the electron beam 25.

Furthermore, please refer to FIGS. 2(A) and 2(B) which respectively shows the top view diagram of the anode and the cathode plates of the field emission display according to the prior art. As shown in FIGS. 2(A) and 2(B), both the anode and the cathode plates 10, 20 can be divided into an active region 10a, 20a, and a non-active region 10b, 20b. Generally, the electrode arranged in the respective active regions 10a, 20a of the anode and the cathode plates 10, 20 is dense and regular patterned, as shown in the scaled up diagrams presented in the right side of FIGS. 2(A) and 2(B), while the electrode existing in the non-active region is usually arranged sparsely or even patterned into an asymmetric hollow electrode or an asymmetric block electrode having no vacant space formed therewithin. This is because that the electrode existing in the non-active region is only used for electrical connection purpose or for placing getter for retaining the vacuum state of the field emission display.

Since the patterns existing in the non-active regions 10b, 20b are usually asymmetric, a stress concentration effect may easily occurs thereon during the high temperature process of the anode and cathode plates 10, 20. Moreover, since the patterns existing in the non-active regions 10b, 20b are totally different from those existing in the active regions 10a, 20a, the stress concentration effect will become serious in the boundary between the non-active regions 10b, 20b and the active regions 10a, 20a. Accordingly, when the stress concentration phenomenon occurs, the glass substrate 12, 22 of the anode or cathode plate 10, 20 crack easily in the sequential process of the anode and cathode plates 10, 20. Although it is well known that the stress concentration phenomenon can be eliminated by a further annealing process, the possible deformation problem caused from the asymmetric pattern in the non-active region 10b, 20b still cannot be overcome through the annealing process. Furthermore, the additional process time and cost for annealing process make it not applicable for manufacturing the anode and cathode plates 10, 20 of the field emission display. Therefore, it is necessary to develop a new technique for abating or eliminating the deformation and the stress concentration effect in the non-active region of the anode or cathode plate for the field emission display.

### SUMMARY OF THE INVENTION

It is a first aspect of the present invention to provide a novel electrode plate for a field emission display. The electrode plate includes an active region having thereon an electrode layer and a non-active region having thereon a dummy electrode. The dummy electrode further has a material which is also used for the electrode layer.

Preferably, the electrode plate is one of an anode plate and a cathode plate for the field emission display.

Preferably, both the electrode layer and the dummy electrode are patterned electrodes.

Preferably, the dummy electrode has a pattern equivalent to what the electrode layer has.

Preferably, the dummy electrode has a block pattern having no vacant space formed therewithin.

Preferably, the dummy electrode has a network pattern.

Preferably, the dummy electrode has a process line width equivalent to what the electrode layer has.

It is a second aspect of the present invention to provide a novel electrode plate for a field emission display. The electrode plate includes an active region having thereon an electrode layer and a non-active region having thereon a dummy structure. The dummy structure further has a coefficient of thermal expansion approximately equivalent to what the electrode layer has.

Preferably, a difference between a coefficient of thermal expansion of the dummy structure and that of the electrode layer is less than 10⁻⁵/° C.

Preferably, the electrode plate is an anode plate for the field emission display.

Preferably, the electrode layer further comprises a transparent electrode and a wiring electrode.

Preferably, the dummy structure has a material which is also used for manufacturing the electrode layer.

Preferably, both the electrode layer and the dummy structure have patterned structures.

Preferably, the dummy structure has a patterned structure equivalent to what the electrode layer has.

Preferably, the dummy structure has a block patterned structure having no vacant space formed therewithin.

Preferably, the dummy structure has a network pattern.

Preferably, the dummy structure has a process line width equivalent to what the electrode layer has.

Preferably, the dummy structure is a dummy electrode which is free from being electrically connected.

Preferably, the electrode plate is a cathode plate for the field emission display.

It is a third aspect of the present invention to provide a novel method for manufacturing an electrode plate of a field emission display. The method includes the steps of (1) providing a substrate; (2) defining an active region and a non-active region on the substrate; and (3) respectively forming a dummy structure and an electrode layer on the active region and the non-active region.

Preferably, the dummy structure and the electrode layer are patterned with the same process.

Preferably, the dummy structure and the electrode layer are respectively patterned with different processes.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a diagram schematically shows a structure of the field emission display according to the prior art;

FIGS. 2(A) and 2(B) are the top view diagrams of the anode and the cathode plates of the field emission display according to the prior art;

FIGS. 3(A) and 3(B) are the top view diagrams of the anode and the cathode plates of the field emission display according to an preferred embodiment of the present invention;

FIGS. 4(A) and 4(B) shows the stress distribution diagrams of the anode plate according to the FIGS. 2(A) and 3(A), respectively; and

FIGS. 5(A) and 5(B) shows the stress distribution diagrams of the cathode plate according to the FIGS. 2(B) and 3(B), respectively.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purposes of illustration and description only; it is not intended to be exhaustive or to be limited to the precise form disclosed.

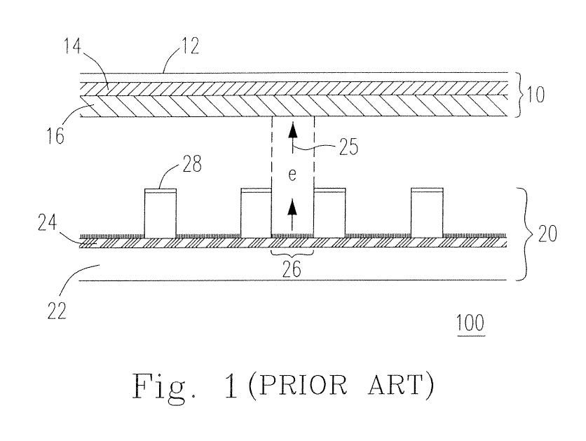

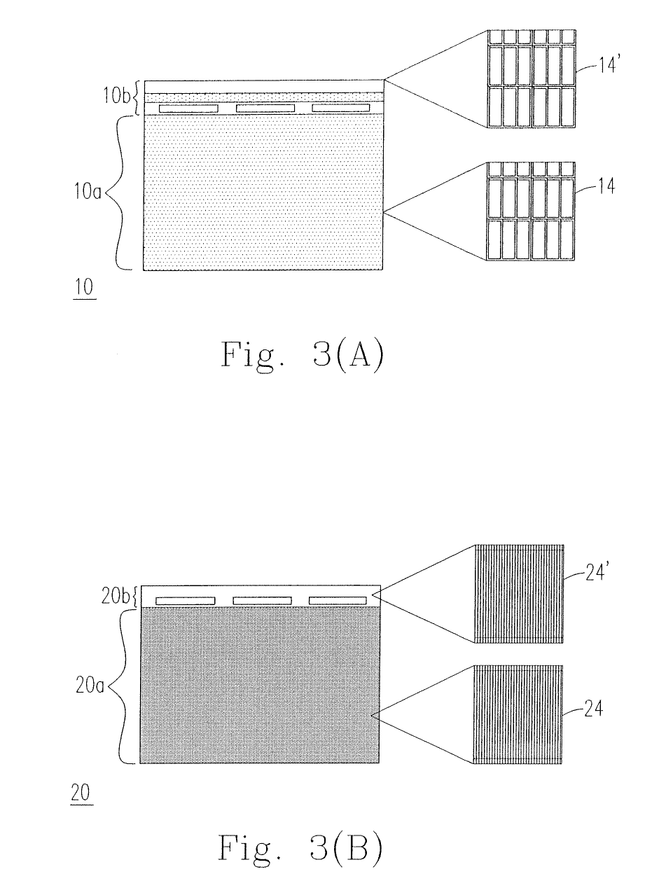

Please refer to FIGS. 3(A) and 3(B) which respectively shows the top view diagram of the anode and the cathode plates 10, 20 of the field emission display according to a preferred embodiment of the present invention. No matter it is the anode plate 10 or the cathode plate 20, the layer structure thereof is very similar to that shown in the field emission display structure of FIG. 1. That is to say the anode plate 10 includes a glass substrate 12 having thereon an anode electrode layer 14 and a fluorescent layer 16, and the cathode plate 20 includes a glass substrate 22 having thereon a cathode electrode layer 24, an electron-emitting source 26 and the gate electrode 28. Furthermore, the anode and the cathode plates 10, 20 are also divided into the active regions 10a, 20a and the non-active regions 10b, 20b. Nevertheless, taking the anode plate 10 as the example, a dummy structure 14′, which has at least one property similar or corresponding to what the anode electrode existing in the active region 10a has, is disposed in the non-active region 10b of the anode plate 10, in order to abate the deformation and the stress concentration phenomenon occurring in the non-active region 10b of the anode plate 10. In a preferred embodiment of the present invention, as shown in FIGS. 3(A) and 3(B), the similar or corresponding property might mean that the respective pattern of the dummy structure 14′, 24′ are similar or corresponding to that of the electrode existing in the respective active region 10a, 20a of the anode and cathode plates 10, 20. Furthermore, the dummy structure 14′, 24′ could be the dummy electrode which is free from being electrically connected. In addition, the dummy structure 14′, 24′ might have a material which is also used for the electrode existing in the active regions 10a, 20a, so that the coefficient of thermal expansion (CTE) in the non-active region 10b, 20b can be approximately equivalent to that in the active region 10a, 20a. Alternatively, the material of the dummy structure 14′, 24′ could be chosen in such a way that a difference of the coefficient of thermal expansion (CTE) between the dummy structure 14′, 24′ and the electrode 14, 24 is less than 10⁻⁵ 1/° C., rather than being chosen from one of the material used for the electrode existing in the active region 10a, 20a. In the preferred embodiments of the present invention, the respective pattern of the dummy structure 14′, 24′ can be configured as a block pattern having no vacant space formed therewithin, and the thickness of the block pattern is used for controlling the deformation tolerance of the non-active region 10b, 20b. Generally, the dummy structure 14′, 24′ may have a thickness ranged from half to one-fifth of the electrode thickness existing in the active region 10a, 20a. Moreover, the dummy structure 14′, 24′ existing in the non-active region 10b, 20b could have a process line width equivalent to what the electrode 14, 24 in the active region 10a, 20a has. Alternatively, the patterns of the dummy structure 14′, 24′ can also be designed as the symmetric patterns, such as the network patterns, in order to abate the stress concentration effect occurring in the non-active region 10b, 20b.

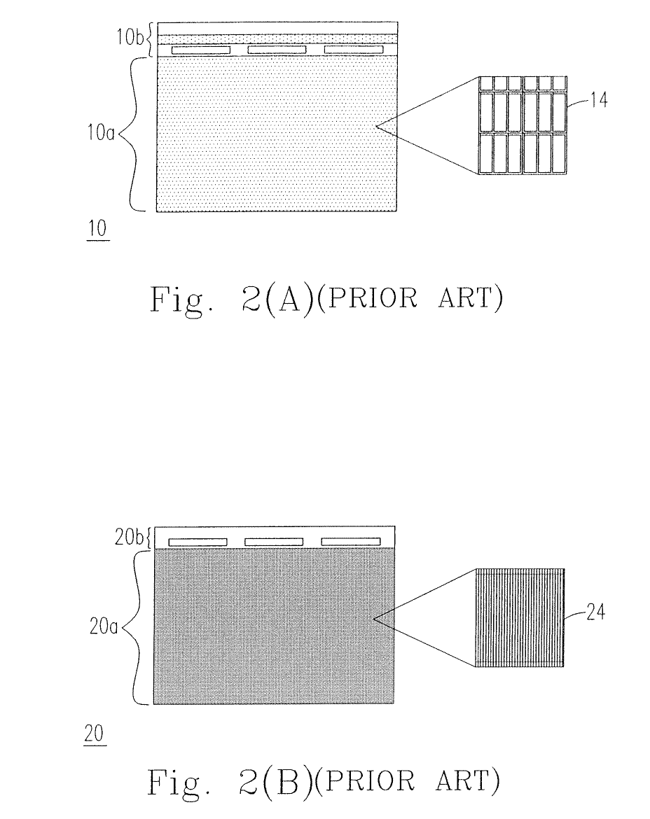

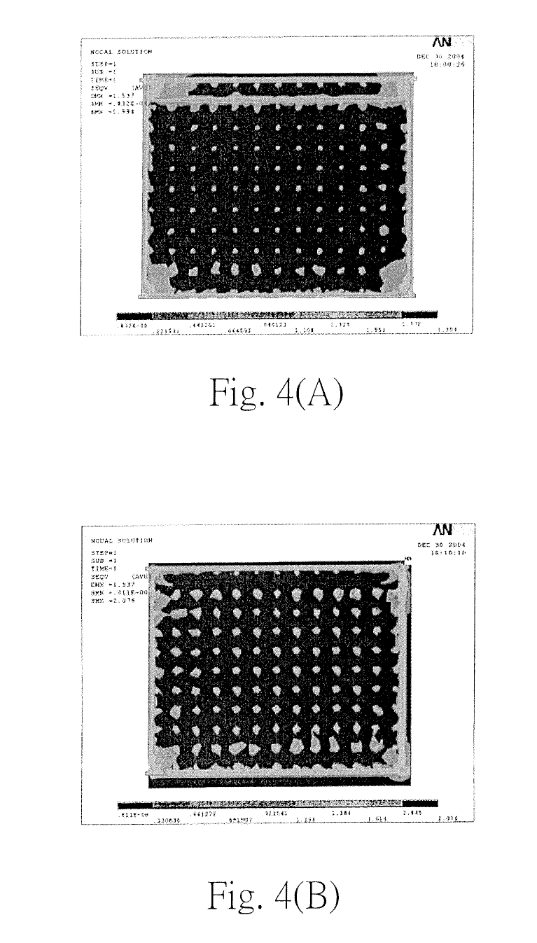

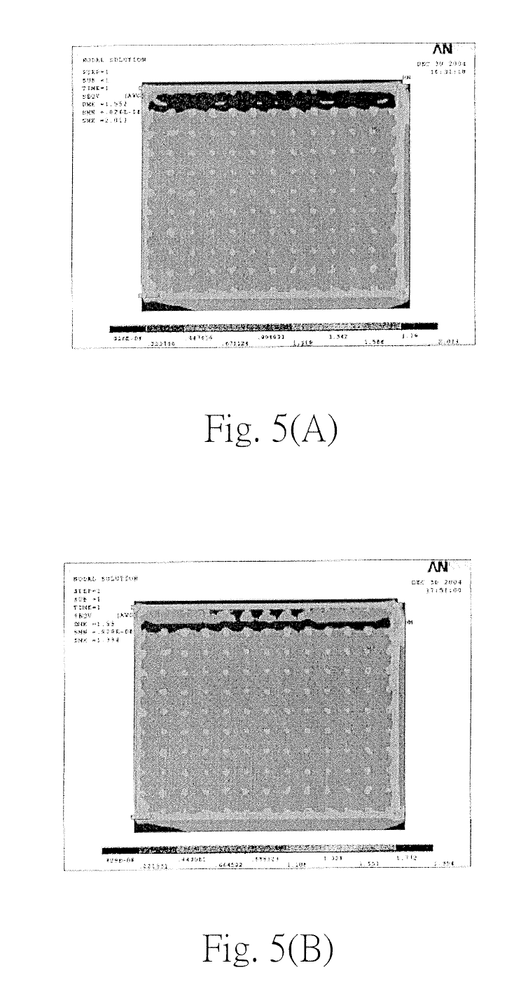

Please refer to FIGS. 4(A) and 4(B), which shows the stress distribution diagrams of the anode plate according to the FIGS. 2(A) and 3(A), respectively As shown in FIG. 4(A), the stress concentration phenomenon occurs in the fringe area of the anode plate 10 and in the boundary area between the active region 10a and the non-active region 10b. However, if a dummy structure is formed in the non-active region 10b of the anode plate 10, as mentioned above corresponding to the FIG. 3(A), the stress concentration phenomenon occurring in the non-active region 10b and in the boundary area between the active region 10a and the non-active region 10b is reduced or even eliminated. Similarly, please refer to FIGS. 5(A) and 5(B), which show the stress distribution diagrams of the cathode plate according to the FIGS. 2(B) and 3(B). The stress concentration phenomenon occurring in the non-active region 20b and in the boundary area between the active region 20a and the non-active region 20b is also reduced or eliminated.

It should be noted that the dummy structure of the present invention can be chosen from one of the materials used for the electrode, or has a line with or pattern corresponding to what the electrode in the active region has. Accordingly, the manufacturing process of the dummy structure is totally compatible with the original process of the anode plate. In most preferred embodiments of the present invention, no additional process is added for manufacturing the dummy structure in the non-active region. Even when the dummy structure is processed in a pattern different from what the electrode layer in the active region has, the manufacturing process of the dummy structure still compatible with those original applicable for the electrode plate of the field emission display. Accordingly, the process time and cost can be controlled as usual.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. An electrode plate for a field emission display, comprising:
an active region having thereon an electrode layer; and
a non-active region having thereon a dummy electrode,
wherein the dummy electrode has a material which is also used for the electrode layer.

2. The electrode plate according to claim 1, wherein the electrode plate is one of an anode plate and a cathode plate for the field emission display.

3. The electrode plate according to claim 1, wherein both the electrode layer and the dummy electrode are patterned electrodes.

4. The electrode plate according to claim 1, wherein the dummy electrode has a pattern equivalent to what the electrode layer has.

5. The electrode plate according to claim 1, wherein the dummy electrode has a block pattern having no vacant space formed therewithin.

6. The electrode plate according to claim 1, wherein the dummy electrode has a network pattern.

7. The electrode plate according to claim 1, wherein the dummy electrode has a process line width equivalent to what the electrode layer has.

8. An electrode plate for a field emission display, comprising:
an active region having thereon an electrode layer; and
a non-active region having thereon a dummy structure,
wherein the dummy structure has a coefficient of thermal expansion approximately equivalent to what the electrode layer has.

9. The electrode plate according to claim 8, wherein a difference between a coefficient of thermal expansion of the dummy structure and that of the electrode layer is less than 10⁻⁵ 1/° C.

10. The electrode plate according to claim 8, wherein the electrode plate is an anode plate for the field emission display.

11. The electrode plate according to claim 10, wherein the electrode layer further comprises a transparent electrode and a wiring electrode.

12. The electrode plate according to claim 11, wherein the dummy structure has a material which is also used for manufacturing the electrode layer.

13. The electrode plate according to claim 8, wherein both the electrode layer and the dummy structure have patterned structures.

14. The electrode plate according to claim 13, wherein the dummy structure has a patterned structure equivalent to what the electrode layer has.

15. The electrode plate according to claim 13, wherein the dummy structure has a block patterned structure having no vacant space formed therewithin.

16. The electrode plate according to claim 13, wherein the dummy structure has a network pattern.

17. The electrode plate according to claim 13, wherein the dummy structure has a process line width equivalent to what the electrode layer has.

18. The electrode plate according to claim 8, wherein the dummy structure is a dummy electrode which is free from being electrically connected.

19. The electrode plate according to claim 8, wherein the electrode plate is a cathode plate for the field emission display.

20. A method for manufacturing an electrode plate for a field emission display, comprising the steps of:
providing a substrate;
defining an active region and a non-active region on the substrate; and
respectively forming a dummy structure and an electrode layer on the active region and the non-active region.

21. The method according to claim 20, wherein the dummy structure and the electrode layer are patterned with the same process.

22. The method according to claim 20, wherein the dummy structure and the electrode layer are respectively patterned with different processes.
